(19) United States
(12) Patent Application Publication
(10) Pub. No.: US 2026/0292380 A1
(43) Pub. Date: Sep. 24, 2026

(54) Magnetic Portable Bluetooth Speaker with Wireless Charging

(71) Applicant: Ali Navid, Round Lake, IL (US)

(72) Inventor: Ali Navid, Round Lake, IL (US)

(21) Appl. No.: 19/266,542

(22) Filed: Jul. 11, 2025

Related U.S. Application Data
(60) Provisional application No. 63/775,930, filed on Mar. 21, 2025.

(51) Int. Cl. H04R 1/02; H02J 7/00

(52) U.S. Cl. CPC H04R 1/028; H02J 7/731; H04R 2420/07; H04R 2420/09; H04R 2499/11

(57) ABSTRACT

A magnetic portable Bluetooth speaker (MagBeat) having wireless charging which can be magnetically coupled to any smart device, such as a mobile phone, and which can wirelessly charge the smart device when magnetically coupled thereto. The magnetic portable Bluetooth speaker is enabled with reverse wireless charging, such that when it is magnetically coupled to a smart device, the onboard battery of MagBeat can be charged. The portable Bluetooth speaker can be paired to any smart device, television, or laptop. And, one MagBeat can be wirelessly linked to a plurality of other MagBeats. The MagBeat can be magnetically coupled to any device using MagSafe™ technology, Qi2™ technology, or by utilizing a magnetic ring.

### CROSS-REFERENCE TO RELATED APPLICATIONS

This application claims priority from U.S. Provisional Application 63/775,930, filed Mar. 21, 2025.

### FIELD OF THE INVENTION

The present invention relates to portable Bluetooth speakers, and more particularly to Bluetooth speakers which combine cutting-edge sound technology, magnetic mounting, wireless charging, and reverse wireless charging.

### BACKGROUND OF THE INVENTION

Portable Bluetooth speakers have been commercially available for many years. However, Bluetooth speakers which are sized under three inches (3″) or 75 mm, typically produce inferior sound, have inferior build quality, and are not “smart”. Moreover, until quite recently, prior Bluetooth portable speakers did not offer magnetic mounting means or wireless charging. Rather, conventional portable Bluetooth speakers were placed on a shelf or table top and connected to a music source, such as a smart device. Further, such portable Bluetooth speakers either required a power source for operation or required a power source for re-charging.

As soon as Apple™ dropped MagSafe on Oct. 13, 2020, iPhone users around the world began purchasing MagSafe adapters (metal or magnetic rings designed to be compatible with MagSafe, with one surface that is sticky) to convert their small speakers into MagSafe compatible speakers. This became a common practice, and became one of the biggest reasons why speaker manufacturers did not add MagSafe into their small speakers, namely because the MagSafe adapters were available and inexpensive. Obviously, these MagSafe adapters quickly were used to mount many other items to an iPhone, including water bottles. enabling a magnetic accessory to be mounted directly to the smart device. Qi2 wireless technology protocol was introduced by the Wireless Power Consortium (WPC) in early 2023 enabling magnetic coupling with Android phones.

In January 2021, Mia Tek began manufacturing small portable speakers with a built-in MagSafe magnetic ring. While the speaker quality was considered quite inferior to conventional Bluetooth speakers,

Wireless charging of speakers, particularly Bluetooth portable speakers, have been in use for more than a decade. Early iterations of these speakers and wireless charging stations were bulky, large, and tethered. Due to the sheer size of these portable speakers, mounting them to a smart phone was not possible. For example, in September of 2012, TDK launched a plug-in, non-portable speaker having wireless charging. In October of 2013, JBL introduced its Power Up Speaker, also a plug-in, non-portable speaker having Qi wireless charging on its top surface. It will be well known to those skilled in this field of art that Qi is the former, non-magnetic version of Qi2. In November 2020, Bang and Olufsen introduced a portable speaker that offered a wireless charger. Again, this speaker was a bulky, stationary type of speaker that was incapable of being carried on a smart phone device due to its size and did not offer any type of magnetic mount.

Prior to the introduction of MagSafe™, MiniS introduced a portable magnetic speaker in mid-2017, the speaker being described as stylishly-designed and having built-in magnets to stick on a wall, for example, to achieve an immersive, rich, and clear multi-room stereo sound. At that time, magnetic mounting to a smart device was not contemplated. However, those in the industry used the built-in magnets of the MiniS to mount it to smart phones, which led to the development of MagSafe™/Qi 2. In May of 2021, MiLi Mag-SoundMate was launched, claiming to be the first magnetic speaker that attaches specifically to smart phones. This device released after the introduction of iPhone's MagSafe™. It became first portable Bluetooth speaker that was compatible with the iPhone's MagSafe™ and to be magnetically mounted thereto; it was introduced at CES (Consumer Electronics Show) in January 2022.

The concept of a portable speaker for magnetic mounting to a smart phone and having wireless charging capabilities first was introduced in July 2023 as MagBeat, the inventive concept being realized as a functional product with exceptional sound quality in March 2024. MagBeat, which is the subject matter of the present invention, is the first portable high-quality speaker that is sufficiently lightweight with such a small form factor such that the user can continue to hold his or her phone, use the speaker, and carry the phone with ease, as if MagBeat is not even mounted to the smart phone. The innovation of MagBeat combines the portability of conventional magnetic speakers with the high-power output and wireless charging of the big, bulky, and tethered portable speakers of yesteryear. Since the launch of MagBeat, there have been numerous, even blatant copycat portable speakers, including larger and bulkier knockoff products. However, none have been able to duplicate the outstanding sound quality and lightweight small form factor.

In addition, MagBeat is a smart speaker with allocated processing power dedicated to smart speaker functions. Further, MagBeat can be programmed to run an operating system, and with the added touch screen, the user directly can interact with the speaker to select and play songs, change settings, and even access games and mobile apps.

### PRIOR ART

Attempts have been made in the prior art to create a magnetic portable Bluetooth speaker. One such speaker is disclosed in U.S. Patent Application 2022/0408168 A1 to Zhu et al., published Dec. 22, 2022 (now terminated) which discloses a basic Bluetooth speaker which has a speaker housing, a loudspeaker, a control circuit board and a magnet, the magnet being arranged outside the magnetic circuit range of the loudspeaker. The magnetic arrangement enables the speaker to be placed on surfaces that are not horizontal. Zhu et al. does not provide for wireless charging of another device or reverse wireless charging. Indeed, Zhu et al. simply teaches a portable Bluetooth speaker which can be attached to any metal surface, such as a table, as well as a mobile phone which is capable of magnetic attraction function.

Of lesser interest, EP Patent Application 1,622,417 A1 to Yeon et al. is directed to an external loudspeaker for use with a mobile phone, the loudspeaker having a magnetic shield to prevent malfunction of the mobile phone caused by a leakage magnetic field. Yeon et al. teaches away from the magnetic portable Bluetooth speaker concept of the present invention. U.S. Patent Application Publication 2023/0263291 A1 to Macdonald discloses a retention device including magnetic attachments to a phone, but does not provide a magnetic portable Bluetooth speaker.

### SUMMARY OF THE INVENTION

The subject matter of the present invention is a magnetic portable Bluetooth speaker comprising a speaker component offering cutting-edge sound technology, a magnetic coupling element adapted to be mounted to any metal surface, including MagSafe™ and Qi2™ technology to connect to mobile phones and other MagSafe™ and/or Qi2™ enabled devices, and a wireless charging component which can wirelessly charge MagSafe™ and/or Qi2™ devices using the MagSafe™ and/or Qi2™ wireless charging protocol, and which also can connect to smart devices not enabled with either MagSafe™ or Qi2™, simply by attaching a MagSafe™ or Qi2™ metal ring to the smart device. The magnetic portable Bluetooth speaker also comprises reverse wireless charging which enables the portable speaker to be charged wirelessly using an external wireless charging bank, such as a smart device using MagSafe™ or Qi2™ technology, or with an onboard battery which functions as a built-in power bank.

Accordingly, it is an object of the present subject matter to provide a magnetic portable Bluetooth speaker providing cutting-edge sound technology comprising a speaker component, a printed circuit board assembly, an onboard battery, and a control panel unit.

It is another object of the present subject matter to provide a magnetic portable Bluetooth speaker having a magnetic coupling element and a wireless charging component which can wirelessly charge MagSafe™ and/or Qi2™ enabled devices using the MagSafe™ and/or Qi2™ wireless charging protocol.

It is still another object of the present subject matter to provide a magnetic portable Bluetooth speaker a magnetic coupling element and a wireless charging component which can wirelessly charge smart devices not enabled with either MagSafe™ or Qi2™, simply by attaching a metal ring, such as a MagSafe™ or Qi2™ metal ring, to the smart device.

It is a yet another object of the present subject matter to provide a magnetic portable Bluetooth speaker having reverse wireless charging which enables the portable speaker to be charged wirelessly using an external wireless charging bank, such as a smart device using MagSafe™ or Qi2™ technology, or with an onboard battery which functions as a built-in power bank.

It is a further object of the present subject matter to provide a magnetic portable Bluetooth speaker which is sufficiently lightweight with a small form factor such that a user can continue to hold his or her mobile phone with the portable speaker magnetically mounted thereto, use the speaker, and carry the phone with the same ease as when the portable speaker is not magnetically mounted to the mobile phone.

It is yet a further object of the present subject matter to provide a magnetic portable Bluetooth speaker having a lithium-ion battery as the onboard battery.

It is still a further object of the present subject matter to provide a magnetic portable Bluetooth speaker having a control panel unit comprising a plurality of buttons to control volume and sound features.

It is an additional object of the present subject matter to provide a magnetic portable Bluetooth speaker comprising a control panel unit having an LED/OLED multi-touch screen.

It is an additional object of the present subject matter to provide a magnetic portable Bluetooth speaker having a control panel unit and a microphone.

It is another object of the present subject matter to provide a magnetic portable Bluetooth speaker which is connected to a power source to charge its onboard battery via an electronic connection, such as an input connection.

It is yet another object of the present subject matter to provide a magnetic portable Bluetooth speaker having an electronic connection which functions as an input connection and an output connection.

It is still another object of the present subject matter to provide a magnetic portable Bluetooth speaker which can be used for charging other smart devices and can be used for powering other devices.

It is a further object of the present subject matter to provide a magnetic portable Bluetooth speaker which can be linked wirelessly to one or more other magnetic portable Bluetooth speakers using AuraCast by Bluetooth or by any other suitable protocol.

It is yet a further object of the present subject matter to provide a magnetic portable Bluetooth speaker which can be paired to a smart device, television, or laptop.

It is an additional object of the present subject matter to provide a magnetic portable Bluetooth speaker which includes higher processing power to host an operating system which can be controlled by a smartphone or by an onboard touchscreen on the speaker to control song selection, video selection, sound settings, mobile app games, and any other function that can be performed by a smart operating system.

It is another object of the present subject matter to provide a magnetic portable Bluetooth speaker which comprises one or more auxiliary outputs or Bluetooth outputs to connect to another audio source, such as Bluetooth headphones, such that the magnetic portable Bluetooth speaker is utilized as a main audio file player.

It is still another object of the present subject matter to provide a magnetic portable Bluetooth speaker which comprises onboard memory to store audio and media files, especially lossless files (formats include FLAC, ALAC, and WAV), for higher quality playback.

It is a further object of the present subject matter to provide a magnetic portable Bluetooth speaker which adds mountability beyond magnetic mounting, including for example, suction mounting, nano-suction mounting, wrist-strap mounting, arm mounting, lanyard/clip and/or custom-made mechanical mounting being the magnetic Bluetooth speaker and other accessories.

These and other objects of the present subject matter are accomplished by providing a magnetic portable Bluetooth speaker comprising a speaker component, a printed board assembly, a control panel unit, and an onboard battery, all disposed within a base unit, a wireless charging component, a magnetic coupling element and an electronic connection, the base unit, wireless charging component, magnetic coupling element, and electronic connection all being disposed within a housing enclosure.

### BRIEF DESCRIPTION OF DRAWINGS

FIG. 1 is a top perspective view of the magnetic Bluetooth speaker of the present subject matter magnetically attached to a smart phone.

FIG. 2 is an exploded view of the magnetic Bluetooth speaker of the present subject matter.

FIG. 3 is a partially exploded view of the magnetic Bluetooth speaker of the present subject matter.

FIG. 4 is a partially exploded side view of the magnetic Bluetooth speaker of the present subject matter.

FIG. 5A is another partially exploded view of the magnetic Bluetooth speaker of the present subject matter.

FIG. 5B is the magnetic Bluetooth speaker of depicted in FIG. 5A, assembled and disposed on a smart phone.

### DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale.

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

The terms “speaker”, “Bluetooth speaker”, “MagBeat”, “magnetic Bluetooth speaker”, “portable speaker” “portable Bluetooth speaker”, derivative terms and similar terms may be used throughout the specification and it is to be understood that such terms are interchangeable and all refer to the magnetic portable Bluetooth speaker with wireless charging of the present subject matter.

Also, it is to be understood that the phraseology and terminology used herein is for the purpose of description and should not be regarded as limiting. The use of the terms “including”, “comprising”, “having”, and variations thereof herein is meant to encompass the items listed thereafter and equivalents thereof as well as additional items.

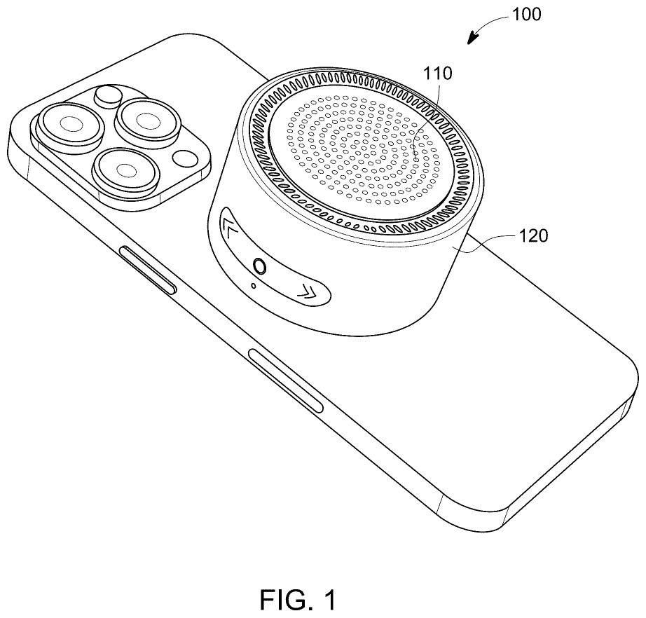

As shown in FIG. 1, a portable Bluetooth speaker 100, hereinafter sometimes referred to as MagBeat, is magnetically coupled to a smart phone device. The MagBeat comprises a speaker component 110 and a housing enclosure 120. Within the housing enclosure is a base unit having a speaker component, a printed circuit board assembly (PCBA), a control panel unit, and an onboard battery disposed therein, a wireless charging component, a magnetic coupling element, and an electronic connection.

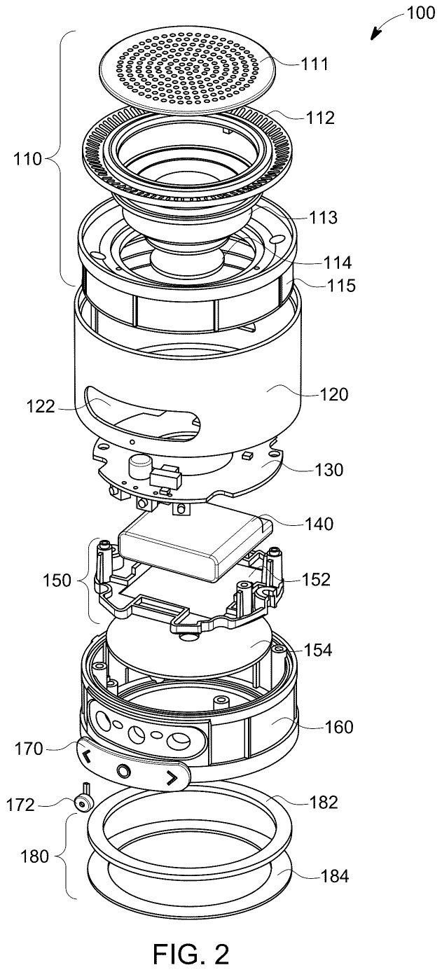

FIG. 2 shows an exploded view of the portable Bluetooth speaker 100 comprising speaker component 110 having a surround grill 111, a decorative surround element 112, a speaker component 113, and a damper element 114 all contained within an upper cover 115. In one embodiment, the surround grill 111 can be composed of an aluminum alloy and the damper element 114 can be composed of an EVA foam material. However, it will be understood that both the surround grill and the damper element can be composed of other materials which do not affect the overall performance or weight of the portable Bluetooth speaker. The speaker component 113 is disposed within a base unit 160, along with a printed circuit board assembly 130, an onboard battery 140, and a control panel unit 170. In one embodiment the control panel unit includes a microphone 172.

The housing enclosure 120 is configured to enclose and retain the base unit 160, a wireless charging component 150, a magnetic coupling element 180, and an electronic connection port. The wireless charging component 150 further comprises a wireless charging stand 152 and a wireless charging coil 154. The magnetic coupling element 180 is in the form of a magnetic loop or ring 182. A rubber element, such as a rubber ring 184, is affixed to the underside of the housing enclosure 120 to prevent surface damage to the metal surface to which the portable speaker is mounted.

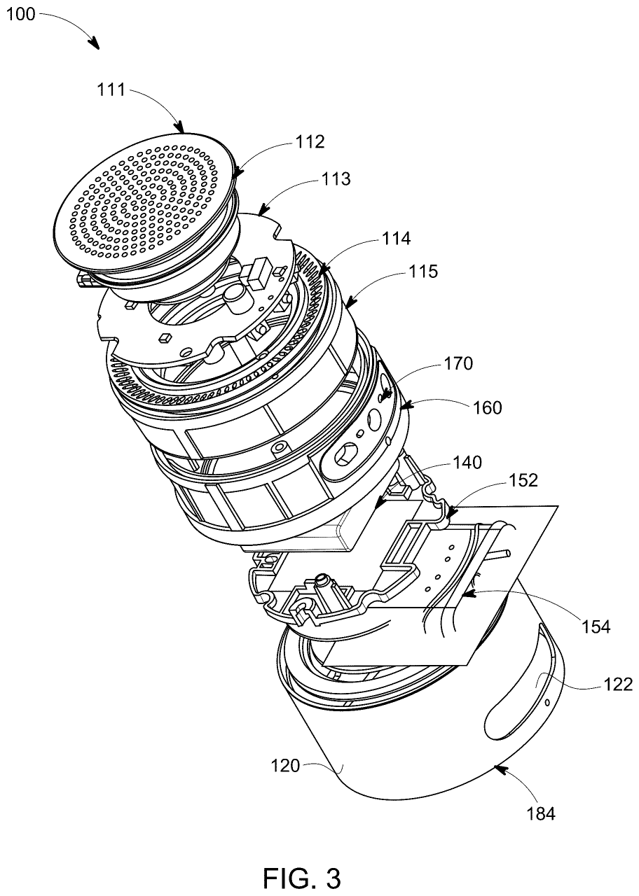

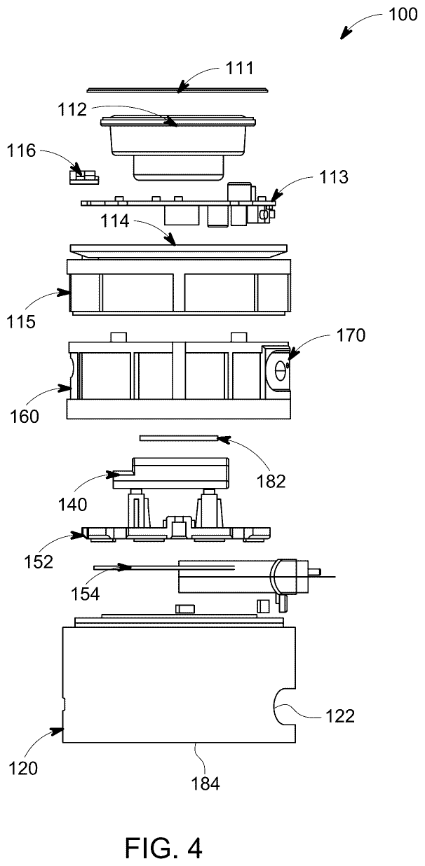

Referring now to FIG. 3 and FIG. 4, the portable Bluetooth speaker 100 is shown in a partial exploded views showing the arrangement of the various components. In FIG. 3 and FIG. 4, the speaker component 110 comprises the surround grill 111, the decorative surround element 112, a speaker component 113, and the damper element 114 all contained within an upper cover 115. The speaker component 110 is disposed within the base unit 160. Also disposed within the base unit 160 is the printed circuit board assembly 130, the onboard battery 140, and the control panel unit 170. The base unit 160, the wireless charging component 150, the magnetic coupling element 180 are disposed in housing enclosure 120 such that the control panel unit 170 is aligned with opening 122 of the housing enclosure. FIG. 4 illustrates the magnetic loop 182 of the magnetic coupling mount 180. Also shown in FIG. 4 is the wireless charging component 150.

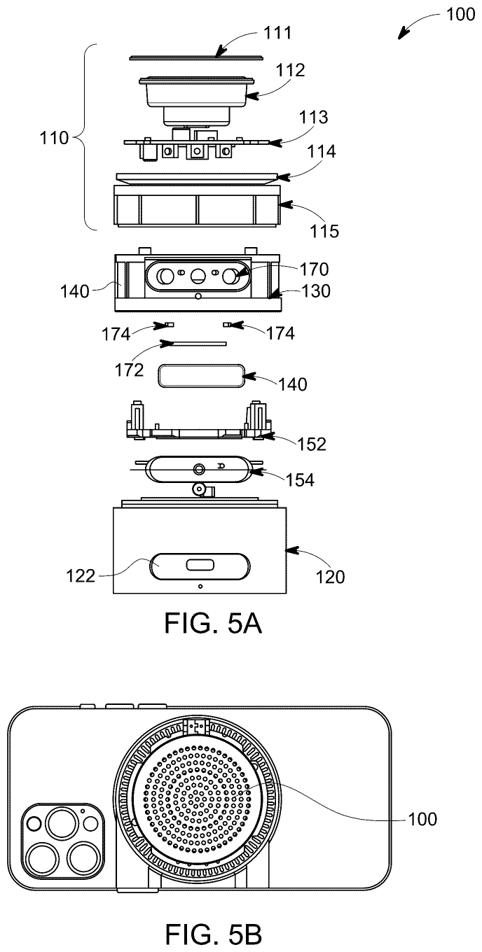

Referring now to FIG. 5A, a partially assembled view of the portable Bluetooth speaker 100 of the present subject matter is shown with speaker component 110, the printed circuit board assembly 130, the onboard battery 140, the control panel unit 170, the wireless charging component 150, and the magnetic attachment component 180, each component assembled and configured to be retained within the housing enclosure 120. Control panel unit buttons 174 are shown which will be installed within the control panel unit 170, along with microphone 172. Not shown in the Figures is an electronic connection port which is disposed on the side opposite of the housing enclosure opening 122, the power source can be any suitable source well known in this field including for example, a USB port. FIG. 5B is a top view of the resulting assembled portable Bluetooth speaker 100 of FIG. 5A, magnetically coupled to a smart phone.

The MagBeat 100 is a small and portable Bluetooth speaker designed to enhance the sound quality of devices capable of a Bluetooth connection. While the primary use of this portable speaker is to be with a smart phone, the MagBeat also can be paired with other devices capable of Bluetooth connectivity, including for example, a TV, a laptop, a smart tablet, and the like. Two or more MagBeats can be paired together to create a True Wireless Stereo experience for your space. Indeed, it is possible to wirelessly link multiple MagBeat speakers, including 100 or more MagBeat speakers, each wirelessly linked.

It is contemplated that the magnetic coupling feature of the present subject matter can be selected from any of the suitable magnetic coupling technologies currently available. However, it will be obvious that the magnetic coupling feature can be adapted and modified to include future types of magnetic technology as this field of magnetic coupling is continually improving and advancing. Suitable examples of the magnetic coupling feature include Apple MagSafe™ magnetic technology which enables secure, wireless charging and accessory attachment for iPhones, primarily through a series of magnets that ensure proper alignment and efficient power transfer, and Qi2™ technology for wireless charging electronic devices using electromagnetic induction.

Qi wireless charging is a technology that allows devices to charge by placing them on a compatible charging pad or surface. Smartphones, smartwatches, and other smart gadgets support Qi wireless charging. Qi2 is an upgraded wireless charging standard developed by the Wireless Power Consortium (WPC), offering faster charging speeds (up to 15 W) and improved efficiency through precise magnetic alignment, inspired by the Apple MagSafe™ technology.

The magnetic portable Bluetooth speaker of the present subject matter utilizes a magnetic coupling element 180 which allows it to easily be attached to the back of an iPhone via the MagSafe™ protocol, to the back of an android mobile phone via Qi2 protocol, or to any smart device having required magnetic profile. For devices not enabled with MagSafe™ or Qi2™, a simple, commercially-available ring can be attached to the device and the magnetic portable Bluetooth speaker of the present subject matter can be magnetically coupled thereto. The magnetic coupling element 180 enables wireless charging of the smart phone or smart device via the wireless charging component 150.

The portable Bluetooth speaker of the present subject matter also can provide reverse wireless charging (e.g. two-way wireless charging). Thus, when magnetically coupled to a smart device, MagBeat can be charged by the smart device. In one embodiment, this two-way charging means that a MagBeat speaker can be set up on a wireless charging magnetic dock, and perform effortlessly and stay charged, and charge a smart device magnetically coupled thereto. Thus, MagBeat's wireless charging component can perform wireless charging to a smart device, and can be charged via reverse wireless charging, including from devices enabled with MagSafe™ wireless charging and Qi2™ wireless charging.

MagBeat's smart PCB is engineered in such a manner to enable a SoC (System on Chip) to be placed directly right onto the PCB. In the past, this practice has resulted in very low computational power, something that only provides Bluetooth connectivity, along with a few other smart functions such as power saving and the like. The inventive MagBeat of the present subject matter takes this technology to the next level, having designed an outstanding PCB with an SoC which allows for playback and wireless charging controls simultaneously. MagBeat has sufficient computational power left over to provide an entire Operating System, such as Android, Linux, or any other custom operating system. With a design that allows internal storage, MagBeat can store audio files and play them back natively to allow for highly quality audio playback, not possible with Bluetooth. Touchscreens on future MagBeat speakers will have the capability of controlling interface of the speaker and even access App store, such that users can download and use custom Apps. MagBeat will be the first speaker on the market to offer all these features in one device. In other words, a computer/speaker hybrid. Among the primary reasons manufacturers have stayed away from designing speaker PCBs with “above and beyond” computational power is (1) too expensive, and (2) the never reimagined speakers that of the present subject matter.

The onboard battery 140 may be any suitable battery capable of powering the portable speaker of the present subject matter. In a preferred embodiment, the onboard battery is a lithium-ion battery. The onboard battery is the primary power source for the portable speaker and performs wireless charging of another smart device magnetically coupled thereto. In one embodiment, the onboard battery functions as a built-in power bank.

The electronic connection port, such as a conventional USB port, can be connected to a secondary power source, suitable examples of which include an external power outlet or a portable power bank. In one embodiment, the electronic connection port is a USB-C input connection which can be connected to a secondary power source to charge the onboard battery. The electronic connection port also can function as an output connection to charge or power other devices.

The control panel unit 170 can comprise a microphone 172 and buttons 174, such as silicone buttons, to control volume and sound features. In one embodiment, an LED/OLED multi touch screen can be used with the portable Bluetooth speaker of the present subject matter. The multi touch screen can be disposed in place of or within the grille 111 or it can be located within the control panel near the physical buttons 174. The multi touch screen is used to display device information, music, and to control the speaker. The multi touch screen can run an entire operating system on the portable Bluetooth speaker, such that MagBeat can be used as smart audio and video player, with the touchscreen and speaker combo offering Google™ Android operating system (open source) so any playstore App can be controlled on the MagBeat device.

In summary, MagBeat, the magnetic portable Bluetooth speaker with wireless charging, addresses and resolves the dual problem of audio performance and charging convenience by combining cutting-edge sound technology with wireless charging and reverse wireless charging, contained in a durable and stylish design. It is a solution for tech-savvy individuals who desire a high-quality sound from their device and demand the added convenience of a wireless charger, all in one portable device.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art.

It is intended that the scope of the invention be defined by the claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, under the provisions of 35 U.S. C § 112, sixth paragraph, unless the element is expressly recited using the phrase “means for . . . ” and no method or process step herein is to be construed under those provisions unless the step, or steps, are expressly recited using the phrase “step(s) for . . . . ”

1. A magnetic portable Bluetooth speaker comprising a speaker component, a printed circuit board assembly, an onboard battery, a wireless charging component, a control panel unit, and magnetic coupling element adapted to be magnetically mounted to a smart device for magnetic wireless charging of the smart device, wherein said magnetic portable Bluetooth speaker can be connected to a primary power source via an electronic connection port to charge its onboard battery.

2. The magnetic portable Bluetooth speaker in accordance with claim 1, wherein said electronic connection port is an input connection port.

3. The magnetic portable Bluetooth speaker in accordance with claim 1, wherein said magnetic wireless charging is selected from the group consisting of MagSafe™ magnetic wireless charging and Qi2™ wireless charging.

4. The magnetic portable Bluetooth speaker in accordance with claim 1, wherein said onboard battery is a lithium-ion battery.

5. The magnetic portable Bluetooth speaker in accordance with claim 1, wherein said onboard battery functions as a built-in power bank and wherein said primary power source is said built-in power bank.

6. The magnetic portable Bluetooth speaker in accordance with claim 1, wherein said electronic connection port functions as an input connection port and an output connection port.

7. The magnetic portable Bluetooth speaker in accordance with claim 6, wherein said electronic connection port can be used for charging other devices and can be used for charging and powering other devices.

8. The magnetic portable Bluetooth speaker in accordance with claim 1, further comprising reverse wireless charging, said reverse wireless charging enabling said magnetic portable Bluetooth speaker to be charged wirelessly using an external wireless charging power bank.

9. The magnetic portable Bluetooth speaker in accordance with claim 8, wherein said external wireless charging power bank is selected from the group consisting of MagSafe™ magnetic wireless charging and Qi2™ wireless charging.

10. The magnetic portable Bluetooth speaker in accordance with claim 9, wherein said external wireless charging power bank is affected from a smart device having said magnetic portable Bluetooth speaker mounted thereon.

11. The magnetic portable Bluetooth speaker in accordance with claim 8, wherein said electronic connection port is an input connection port.

12. The magnetic portable Bluetooth speaker in accordance with claim 8, wherein said onboard battery is a lithium-ion battery.

13. The magnetic portable Bluetooth speaker in accordance with claim 8, wherein said onboard battery functions as a built-in power bank and wherein said primary power source is said built-in power bank.

14. The magnetic portable Bluetooth speaker in accordance with claim 8, wherein said electronic connection port functions as an input connection and an output connection.

15. The magnetic portable Bluetooth speaker in accordance with claim 14, wherein said electronic connection port can be used for charging other devices and can be used for powering other devices.

16. A magnetic portable Bluetooth speaker comprising
a. a base unit having a speaker component, a printed circuit board assembly, a control panel unit, and an onboard battery disposed therein;
b. a wireless charging component, and
c. a magnetic coupling element adapted to be magnetically mounted to a smart phone for magnetic wireless charging,
wherein said magnetic portable Bluetooth speaker can be connected to a primary power source via an electronic connection port to charge its onboard battery.

17. The magnetic portable Bluetooth speaker in accordance with claim 16, wherein said control panel unit comprises a plurality of buttons to control volume and sound features, and a microphone.

18. The magnetic portable Bluetooth speaker in accordance with claim 16, further comprising an LED/OLED multi-touch screen.

19. The magnetic portable Bluetooth speaker in accordance with claim 16, wherein said wireless charging component also can provide reverse wireless charging.

20. The magnetic portable Bluetooth speaker in accordance with claim 16, wherein a plurality of said portable Bluetooth speakers can be wirelessly linked to each other.

21. The magnetic portable Bluetooth speaker in accordance with claim 16 which can be paired to a smart device, television, and laptop.
